(19) United States
(12) Patent Application Publication
(10) Pub. No.: US 2009/0174163 A1
(43) Pub. Date: Jul. 9, 2009

(54) PERSONAL TRANSPORTATION DEVICE FOR SUPPORTING A USER'S FOOT

(75) Inventor: RYAN FARRELLY, San Diego, CA (US)

Correspondence Address: KNOBBE MARTENS OLSON & BEAR LLP, 2040 MAIN STREET, FOURTEENTH FLOOR, IRVINE, CA, 92614, US

(73) Assignee: FREELINE SPORTS, INC., Irvine, CA (US)

(21) Appl. No.: 12/350,864

(22) Filed: Jan. 8, 2009

Related U.S. Application Data
(60) Provisional application No. 61/019,796, filed on Jan. 8, 2008.

(51) Int. Cl. B62M 1/00

(52) U.S. Cl. 280/87.041

(57) ABSTRACT

A personal transportation device can include a truck having a pair of wheels, a support structure attached to each of the wheels, and an undercarriage attached to the support structure. A platform can be situated above the truck in relation to a surface or the ground, the platform being operable to receive a user's foot. Movement of the personal transportation device can be caused by a swivel motion of the rider.

### CROSS-REFERENCE TO RELATED APPLICATIONS

This application claims benefit under 35 U.S.C. § 119(e) to U.S. Provisional Patent Application No. 61/019,796, filed Jan. 8, 2008, which is incorporated in its entirety by reference herein.

This application shares inventorship with and is related to U.S. patent application number 11/386,822 filed on Mar. 23, 2006 (Publication No. US 2006-0186617), which is a continuation-in-part of U.S. patent application Ser. No. 10/616,969, filed Jun. 13, 2006 (now U.S. Pat. No. 7,059,613, granted Jun. 13, 2006). U.S. Publication No. 2006-0186617 and U.S. Pat. No. 7,059,613 are hereby incorporated in their entireties by reference herein.

### BACKGROUND OF THE INVENTIONS

1. Field Of The Inventions

The present inventions are directed to personal transportation devices. More particularly, the present inventions are directed to personal transportation devices that support a single foot of a user.

2. Description Of The Related Art

So-called “extreme sports” are rapidly gaining popularity as entertaining, exciting, and healthy alternatives to traditional modes of exercise and entertainment. For example, skateboarding contests are routinely held nationwide, and the sport's popularity has carried over into such popular media as video games and movies. Pro-skateboarders now have enough name recognition to warrant marketing and promotion contracts for various products. Similarly, in-line skating, street luge, and trick bike riding have all seen large increases in participation. Additionally, many “skate parks” have been built across the United States and include features specifically designed for skating-type sports.

In order to continue the growth present in this segment of sports and entertainment, new extreme sports must be developed or existing sports improved upon. Extreme sport participants are already seeking new methods and devices to challenge their skills and provide greater excitement. For instance, skateboarding has evolved from maneuvering on flat surfaces, to down hill racing, to half-pipes and ramps, to the purpose-built skate parks (noted above) that simulate a variety of challenges within a small space. As the challenges have evolved, so has the technology of the skateboards. Simple two axle, wheeled wooden planks have been replaced by computer designed composite boards rolling on high-precision plastic wheels. Newer skateboards even include suspensions to aid the rider.

Skateboarders, in-line skaters, and the like continue to encounter certain limitations because their equipment can only be used on certain types of surfaces. Once they have developed their skills, they are effectively limited to paved surfaces. For recreational users, this can be extremely limiting as local zoning laws often prohibit skateboarding, roller skating or other recreational activities on public property.

Currently available extreme sport and personal transportation devices limit acrobatic moves, hamper maneuverability and generally do not fully satisfy specific needs in personal transportation. These personal transportation devices have two separate platforms that support each foot of the rider. The personal transportation devices have a tandem wheel configuration that is similar to “inline skates.” Unlike inline skates, these personal transportation devices do not have a foot enclosure. Also, the rider's foot is placed approximately perpendicular to the direction of movement of the tandem wheels in a position that is approximately ninety degrees from the foot position of an in-line skate.

Unlike in-line skates, which are propelled using the thrust of the leg in the direction of the wheels, the person transportation device is propelled using a swivel motion. Likewise, the rider of the personal transportation device is standing and does not have to be attached.

U.S. Publication No. 2006-0186617, as illustrated in FIGS. 11-13 therein, discloses a similar personal transportation device. One commercially available version of such a personal transportation device includes a single axle configured for both wheels of the device. The axle is formed with a single rod, bent numerous times, with the remainder of the device molded in aluminum over the single, bent rod.

### SUMMARY OF THE INVENTIONS

An aspect of at least one of the embodiments disclosed herein includes the realization that it would be desirable to have a personal transportation device which provides both structural support for the rider and enhanced rider experience.

Thus, in accordance with an embodiment, a personal transportation device can comprise a platform configured to receive a user's foot, the platform including at least one removable layer comprised of rubber, and a truck attached to the platform, the truck having two wheels, a support structure attached to the two wheels, and an undercarriage attached to the support structure. The undercarriage can have a generally V-shaped formation when viewed from one side, and can be connected to the platform with fasteners. The support structure can comprise two generally L-shaped arms forming a generally S-shaped structure, the ends of each L-shaped arm having an opening configured to receive axles for the wheels. The L-shaped arms can have a generally I-beam shaped cross-section along at least a portion of the arms, and the wheel axles can comprise bolts.

Another aspect of at least one of the embodiments disclosed herein includes the realization that removable and detachable platform layers can provide a rider with a variety of gripping surfaces for their feet, as well as a variety of ways to alter the aesthetic appearance of the device. For example, depending on the conditions outside, the rider may wish to have a surface with high frictional grip, such as rubber, whereas on a different day the rider may wish to have only a wooden platform surface.

Thus, in accordance with an embodiment, a personal transportation device can comprise a platform configured to receive a user's foot, the platform including at least one removable layer, and a truck attached to the platform, the truck having at least one wheel, a support structure attached to the wheel, and an undercarriage attached to the support structure. The undercarriage can be connected to the platform, and the support structure can comprise arms, the ends of each arm having an opening configured to receive axles for the at least one wheel.

Another aspect of at least one of the embodiments disclosed herein includes the realization that personal transportation devices can be used by people of various sizes and weights. Adding more material to the device, particularly underneath the platform, to provide support for the users can lead to greater manufacturing cost. A lightweight, yet stable support structure underneath the platform would be advantageous.

Thus, in accordance with an embodiment, a personal transportation device can comprise a platform configured to receive a user's foot, and a truck attached to the platform, the truck having at least one wheel, a support structure attached to the wheel, and an undercarriage attached to the support structure. The undercarriage can be connected to the platform via fasteners, and the support structure can comprise two generally L-shaped arms forming a generally S-shaped structure, the ends of each L-shaped arm having an opening configured to receive axles for the at least one wheel.

In accordance with yet another embodiment, a personal transportation device can comprise a platform configured to receive a user's foot, a truck removably attached to the platform, the truck having two wheels, a support structure attached to the two wheels, and an undercarriage attached to the support structure. The undercarriage can have a generally V-shaped formation formed by upwardly extending arms which diverge away from one another and terminate at first and second ends, respectively, the first and second ends being connected to one another with a strut.

### BRIEF DESCRIPTION OF THE DRAWINGS

These and other features and advantages of the present embodiments will become more apparent upon reading the following detailed description and with reference to the accompanying drawings of the embodiments, in which:

FIG. 1A is a bottom plan view of a personal transportation device constructed in accordance with an embodiment, with a single wheel removed from an axle;

FIG. 1B is a right side elevational view of the personal transportation device;

FIG. 1C is partial view of the axle of FIG. 1A;

FIG. 2 is an exploded perspective view of the personal transportation device;

FIG. 3A is a top plan view of a wheel axle of the personal transportation device;

FIG. 3B is a front side elevational view of the wheel axle of FIG. 3A;

FIG. 3C is a cross-sectional view of the wheel axle of FIG. 3B;

FIG. 4A is a top plan view of a skate pad assembly of the personal transportation device;

FIG. 4B is a right side elevational view of the skate pad assembly of FIG. 4A;

FIG. 5A is top plan view of the truck of the personal transportation device;

FIG. 5B is a right side elevational view of the truck of FIG. 5A;

FIG. 5C is a top plan cross-sectional view of a portion of the truck of FIG. 5A, including two arms;

FIG. 5D is a top, front, and right side perspective view of the truck of FIG. 5A;

FIG. 5E is a front side elevational view of the truck of FIG. 5A;

FIG. 6A is a right side elevational view of a wheel of the personal transportation device;

FIG. 6B is a front side elevational view of the wheel of FIG. 6A; and

FIG. 6C is cross-sectional view of the wheel of FIG. 6B.

### DETAILED DESCRIPTION OF THE PREFERRED EMBODIMENT

An improved personal transportation device 12 (“PTD 12”) is disclosed herein. The embodiments disclosed herein are described in the context of a single, two-wheeled transportation device with a platform for one foot because the embodiments disclosed herein have particular utility in this context. However, the embodiments and inventions herein can also be applied to personal transportation devices with other numbers of wheels and/or platforms. Personal transportation devices, as disclosed herein, can include, but are not limited to, those devices used in a sporting or exercise activity, such as skates, skateboards, and the like.

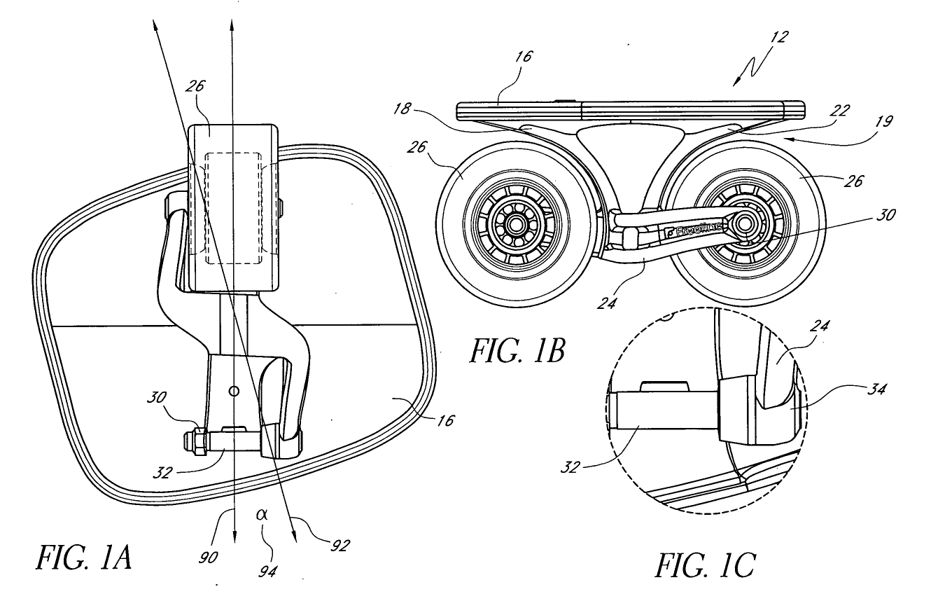

With reference to FIGS. 1A, 1B, and 1C, the personal transportation device 12 can comprise a platform 16, at least one wheel 26, and at least one wheel axle 32. The wheel axle 32 can comprise, for example, a bolt configured to fit inside (e.g. threaded through) an opening 34 of the PTD 12. A fastener 30, such as for example a nut, can be used to secure the wheel 26 against the wheel axle 32. With reference to FIG. 1B, the PTD 12 can include an undercarriage beneath the platform 16, which for example can include connecting frames 18, 22. The undercarriage can be connected to arms 24. The configuration of the connecting frames 18, 22, and the arms 24 can comprise a truck 19.

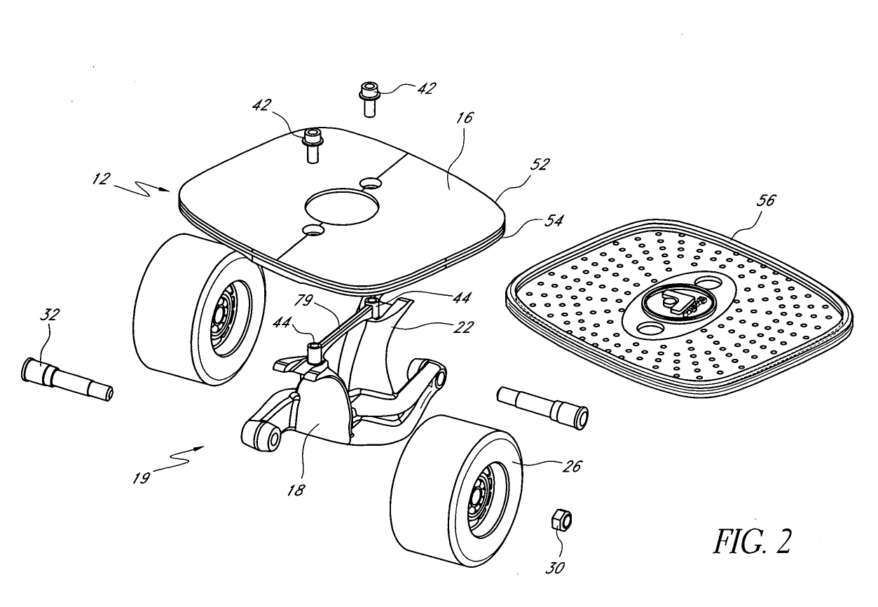

With reference to FIG. 2, the platform 16 can be secured to the undercarriage using two deck fasteners 42 threaded into two undercarriage shafts 44. The platform 16 can be multilayered as indicated by a base layer 54, a deck layer 52, and a skid layer 56. The skid layer 56 can be optional and removable to provide an improved riding experience to the user of the PTD 12. In yet other embodiments, the platform 216 can be made partially or entirely out of wood, to give the PTD 12 a more skateboard-like look.

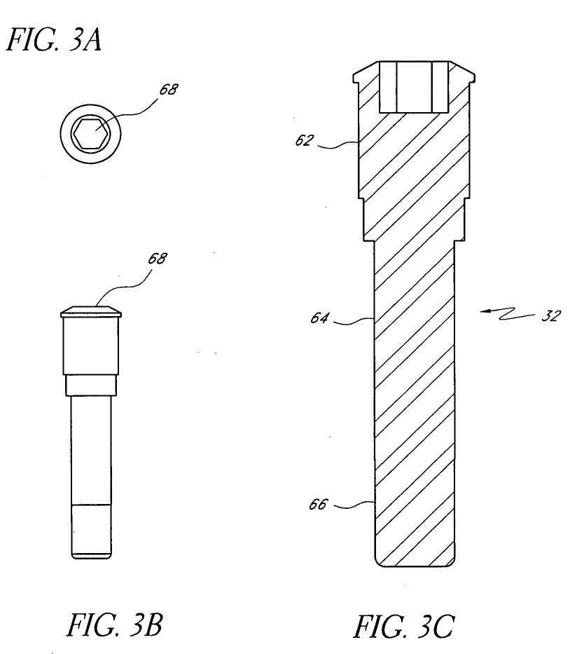

With reference to FIG. 3, and as described above, the PTD 212 can include a wheel axle 32 for connecting the wheel 26 to the truck 19. The wheel axle 32 can have a tri-level design having a first shaft portion 62 near a head 68 of the axle, a second shaft portion 64 for supporting the wheel 26, and third shaft portion 66 at the end for attaching the fastener 30. In some embodiments, the third shaft portion 66 can have a smaller diameter or cross-sectional area than the second shaft portion 64, and the second shaft portion 64 can have a smaller diameter or cross-sectional area than the first shaft portion 62. Such a configuration, when used with the fastener 30, can help to secure the wheel 26 in place within the frame of the truck 19. Each of the wheel axles 32 can be formed for example out steel, or other suitable material.

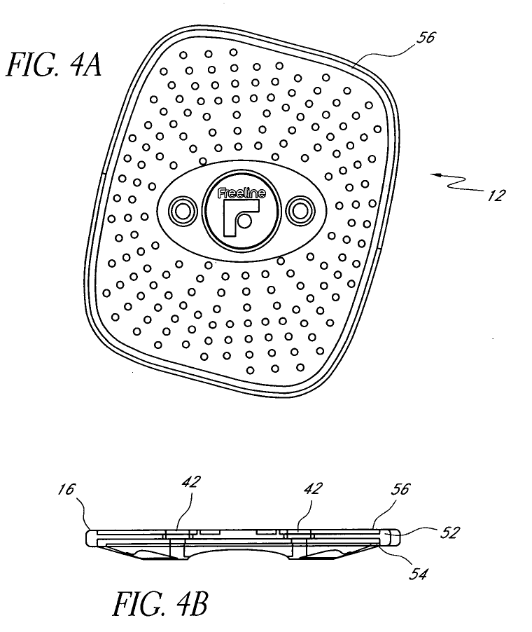

With reference to FIGS. 4A and 4B, and as described above, the platform 16 can have a skid layer 56, a deck layer 52, and a base layer 54. The skid layer 56 can include bumps or protrusions to aid in gripping a user's foot to the platform. The skid layer 56 can further include markings, etchings, or advertising, as illustrated. With reference to FIG. 4B, the two undercarriage shafts 44 can allow the platform 16 to be connected to the undercarriage 18 (not shown) via the two deck fasteners 42.

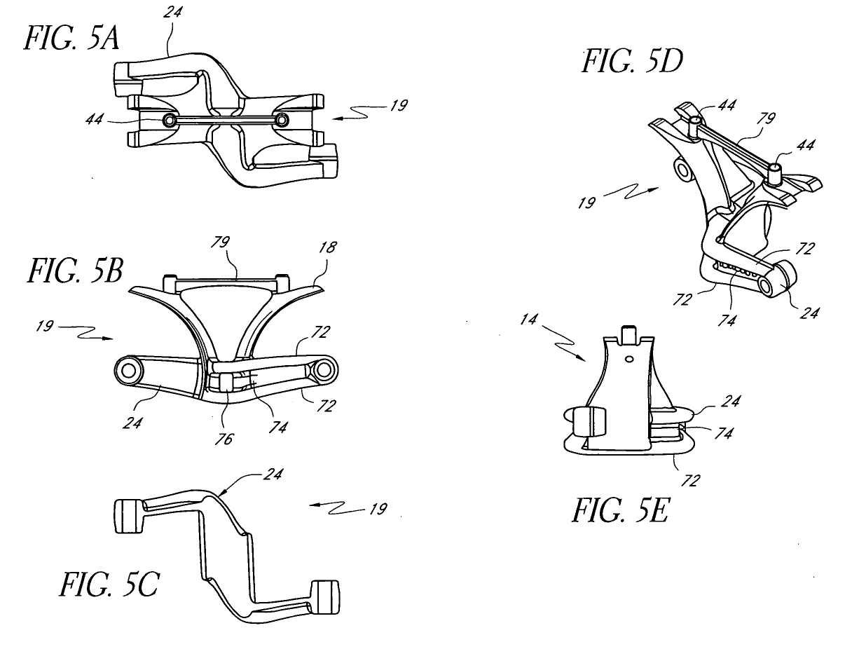

With reference to FIGS. 5A-5E, the PTD 12 and truck 19 can have a support structure with opposing endpoints for receiving the wheels, including a pair of generally L-shaped arms 24 extending from the endpoints to a center point, so that when the L-shaped arms are joined at the center point a generally S-like beam support structure is formed. The S-shaped configuration can provide stability to the truck 19. While the embodiment illustrated in the figures shows arms 24 which maintain wheels 26 spaced apart from one another (i.e. not in-line), in other embodiments the wheels 26 can have an in-line configuration.

With continued reference to FIGS. 5A-5E, the arms 24 can have an I-beam configuration with an arm flange 72 and an arm web 74. An I-beam configuration can provide stability and strength to the arms 24 while reducing the amount of weight and/or material needed to form the arms 24. Additionally, at the center of the I-beam and/or truck 19, an arm void 76 can be present, thereby further reducing the amount of material needed during manufacturing. The arms 24 and/or undercarriage can be formed, for example, from plastic, stainless steel, or other suitable material. In some embodiments, the arms 24 and/or undercarriage can be formed by bending steel numerous times to give it strength, and then adding an aluminum coating. In yet other embodiments, the arms 24 and/or undercarriage can be formed out of stainless steel to give the truck 19 and PTD 12 added strength. The stainless steel arms 24 can be formed as one piece, or as multiple pieces which are then assembled or connected together. Further, in some embodiments an investment casting process can be used to significantly increase production rates during manufacturing.

With reference to FIGS. 5B and 5D, the undercarriage can be connected to and/or formed integrally with the arms 24. The undercarriage can have a generally V-shaped formation with extending arms which diverge away from one another and terminate at first and second ends, providing added support to the platform 16. In at least some embodiments, the side edges of the V-like structure can be radially contoured. In at least some embodiments, the width of the undercarriage can be dimensioned to be smaller than the platform 16, and the two wheels 26 can be spaced apart approximately the width of one foot.

In some embodiments, the V-shaped formation can further include a strut portion 79 connecting the first and second ends. The strut portion 79 can provide added stability to the device. For example, without any strut, a resulting spreading force can result from a rider's weight and cause the ends of the V-shaped formation to move away from each other. When the platform 16 is attached, such a spreading force can be applied to the platform 16 itself, causing the first and second ends of the V-shaped formation to spread apart from one another and deform of the platform. With the strut portion 79, not all of the spreading force is applied to the platform 16 itself.

With continued reference to FIGS. 5B and 5D, the fasteners 44 can be positioned on the first and second ends of the V-shaped formation, such that the platform 16 is removable from the truck 19. In some embodiments, the truck 19 can be monolithically formed, and removable from the platform 16.

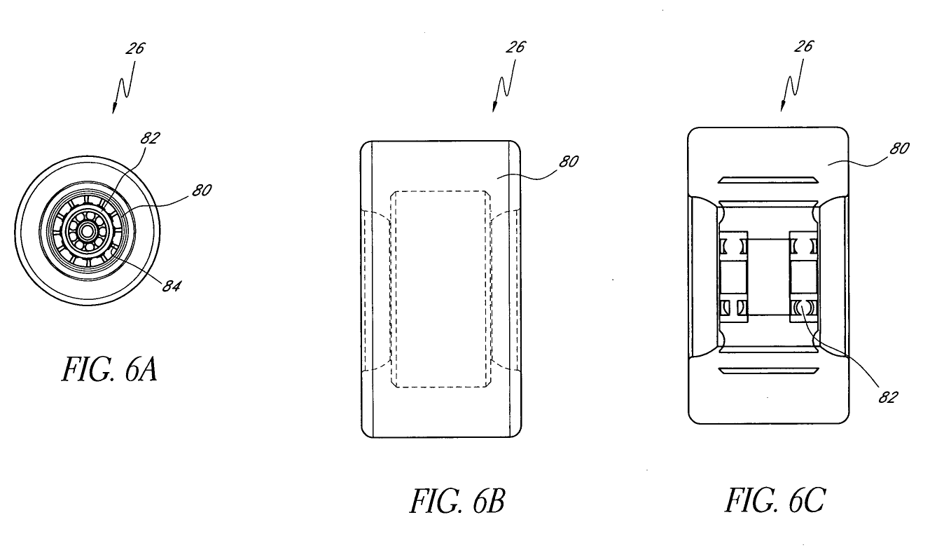

With reference to FIGS. 6A, 6B, and 6C, the wheels 26 can have a cylindrical wheel support 80, the exterior of which can contact the ground and the interior of which can be connected to spokes 84. The spokes can be connected to a series of bearings 82 that can allow a rotational surface between the wheel axle 32 and the spokes 84.

The assembled PTD 12 of FIGS. 1A-6C can be operated by placing the wheel 26 on the ground and the rider's foot on the platform 16. During at least one type of operation, one PTD 12 can be placed beneath each foot of the user. With reference to FIG. 1A, the direction of travel for the PTD 12 can be indicated by the travel vector 90. The foot can be placed in the direction along the foot vector 92, forming an angle 94. Movement of the PTD 12 can be caused by a swivel motion of the rider.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments can be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A personal transportation device, comprising:
a platform configured to receive a user's foot, the platform including at least one removable layer comprised of rubber;
a truck removably attached to the platform, the truck having two wheels, a support structure attached to the two wheels, and an undercarriage attached to the support structure;
wherein the undercarriage has a generally V-shaped formation formed by upwardly extending arms which diverge away from one another in an upward direction and terminate at first and second ends, respectively, the first and second ends being connected to one another with a strut;
wherein the support structure comprises two generally L-shaped arms forming a generally S-shaped structure, the ends of each L-shaped arm having an opening configured to receive axles for the wheels;
wherein the L-shaped arms have a generally I-beam shaped cross-section along at least a portion of the arms; and
wherein the wheel axles each comprise a first axle end configured to engage the support structure, and a second axle end configured to receive a fastener in order to hold a wheel onto the axle.

2. The personal transportation device of claim 1, wherein the wheels are in-line.

3. The personal transportation device of claim 1, wherein the S-shaped structure includes an open void in its center.

4. The personal transportation device of claim 1, wherein the L-shaped arms have a top flange, a bottom flange, and a web interposed between the top flange and bottom flange.

5. The personal transportation device of claim 1, wherein the support structure includes at least one nut and bolt pair, the bolt located within the opening of the support structure.

6. A personal transportation device, comprising:
a platform configured to receive a user's foot, the platform including at least one removable layer;
a truck attached to the platform, the truck having at least one wheel, a support structure attached to the wheel, and an undercarriage attached to the support structure;
wherein the undercarriage is connected to the platform; and
wherein the support structure comprises at least one arm, the end of each arm having an opening configured to receive axles for the at least one wheel.

7. The personal transportation device of claim 6, wherein the at least one removable layer is comprised of rubber.

8. The personal transportation device of claim 6, wherein the at least one wheel comprises two wheels.

9. The personal transportation device of claim 6, wherein the undercarriage is connected to the platform with two fasteners.

10. A personal transportation device, comprising:
a platform configured to receive a user's foot;
a truck attached to the platform, the truck having at least one wheel, a support structure attached to the wheel, and an undercarriage attached to the support structure;
wherein the undercarriage is connected to the platform via fasteners; and
wherein the support structure comprises two generally L-shaped arms forming a generally S-shaped structure, the ends of each L-shaped arm having an opening configured to receive axles for the at least one wheel.

11. The personal transportation device of claim 10, wherein the axles comprise bolts.

12. The personal transportation device of claim 11, wherein the bolts are secured in place inside the opening by nuts.

13. The personal transportation device of claim 10, wherein the axles comprise a first portion having a first diameter, a second portion having a second diameter smaller than that of the first portion, and third portion having a diameter smaller than that of the second portion, and wherein the wheel is fitted over the second portion.

14. The personal transportation device of claim 10, wherein the L-shaped arms are formed separately and then joined together during assembly of the device.

15. The personal transportation device of claim 10, wherein the L-shaped arms are comprised of stainless steel.

16. The personal transportation device of claim 10, wherein the L-shaped arms have a generally I-beam shaped cross-section along at least a portion of the arms.

17. The personal transportation device of claim 10, wherein the L-shaped arms have a top flange, a bottom flange, and a web interposed between the top flange and bottom flange.

18. The personal transportation device of claim 10, wherein the platform is made of wood.

19. The personal transportation device of claim 10, wherein the wheels are spaced apart from one another by approximately the width of a human foot.

20. A personal transportation device, comprising:
a platform configured to receive a user's foot; and
a truck removably attached to the platform, the truck comprising two wheels, a support structure attached to the two wheels, and an undercarriage attached to the support structure;
the undercarriage comprising a generally V-shaped formation formed by upwardly extending arms which diverge away from one another and terminate at first and second ends, respectively; and
a strut directly connecting the first and second ends of the generally V-shaped formation.

21. The personal transportation device of claim 20, wherein the first and second ends are configured to attach to the platform.

22. The personal transportation device of claim 20, wherein the truck is monolithically formed and is removably attached to the platform.
